(19) United States
(12) Patent Application Publication
(10) Pub. No.: US 2017/0117726 A1
(43) Pub. Date: Apr. 27, 2017

(54) PORTABLE CHARGING STATION

(71) Applicant: MTD PRODUCTS INC, Valley City, OH (US)

(72) Inventors: Lincoln Jore, Tempe, AZ (US); Jeff Kucera, Medina, OH (US); Duke P. Matelske, II, Strongsville, OH (US)

(21) Appl. No.: 15/332,072

(22) Filed: Oct. 24, 2016

Related U.S. Application Data
(60) Provisional application No. 62/244,836, filed on Oct. 22, 2015.

(51) Int. Cl. H02J 7/00; B60L 11/18

(52) U.S. Cl. CPC H02J 7/0027; H02J 7/0045; B60L 11/1818

(57) ABSTRACT

A portable charging station for providing portable power and rechargeability, particularly for handheld battery-powered outdoor power tools, is provided. The charging station includes a housing having a plurality of charging ports operatively connected thereto, wherein the charging ports provide a plurality of different forms of connectors as well as a plurality of different types of output power from the charging ports. The charging station includes a primary power source that is rechargeable and selectively powers each of the charging ports.

### CROSS-REFERENCE TO RELATED APPLICATIONS

This application claims the benefit of U.S. Provisional Application No. 62/244,836, filed Oct. 22, 2015, the entire disclosure of which is hereby incorporated herein by reference.

### FIELD OF THE INVENTION

The present invention is directed to a portable charging station for providing a plurality of different forms power output.

### BACKGROUND OF THE INVENTION

Homeowners and professional landscapers alike utilize corded as well as battery-operated, rechargeable power tools such as string trimmers, blowers, hedge trimmers, tillers, and the like to perform lawn maintenance. Rechargeable batteries are known to have limited life, but are very convenient for use with lawn maintenance handheld tools. Corded tools must be used within a limited distance from an outlet. As such, these tools have a limited range and duration of operation.

### BRIEF SUMMARY OF THE INVENTION

In one aspect of the present invention, a portable charging station is provided. The portable charging station includes a housing and a plurality of wheels rotatably connected to the housing. The portable charging station further includes a primary power source, wherein the primary power source is rechargeable. A plurality of charging ports are operatively connected to the primary power source, and each of the plurality of charging ports providing output power therefrom. At least two of the plurality of charging ports provides a different form of output power.

In another aspect of the present invention, a portable charging station is provided. The portable charging station includes a housing and a plurality of wheels rotatably connected to the housing. The portable charging station further includes a primary power source, wherein the primary power source is rechargeable. A first charging port is operatively connected to the primary power source and receives power therefrom, wherein said first charging port includes a pair of studs for providing a short burst of power output. A second charging port is operatively connected to the primary power source and receives power therefrom, wherein the second charging port includes at least one receptacle for providing a continuous power output. A third charging port is operatively connected to the primary power source and receives power therefrom, wherein the third charging port includes at least one recharging station for providing a rechargeable power output. The third charging port is configured to receive a secondary rechargeable battery therein.

Advantages of the present invention will become more apparent to those skilled in the art from the following description of the embodiments of the invention which have been shown and described by way of illustration. As will be realized, the invention is capable of other and different embodiments, and its details are capable of modification in various respects.

### BRIEF DESCRIPTION OF SEVERAL VIEWS OF THE DRAWINGS

These and other features of the present invention, and their advantages, are illustrated specifically in embodiments of the invention now to be described, by way of example, with reference to the accompanying diagrammatic drawings, in which:

FIG. 1 is an embodiment of a portable charging station; and

FIG. 2 is the portable charging station shown in FIG. 1, wherein the housing is shown as being transparent;

FIG. 3 is a schematic diagram of the charging station of FIG. 1;

FIG. 4 is a schematic diagram of another embodiment of a charging station;

FIG. 5 is a schematic diagram of yet another embodiment of a charging station;

FIG. 6 is an embodiment of a charging station having a wireless signal generator that communicates with a handheld device; and

FIG. 7 is an embodiment of a charging station having an internal combustion engine for recharging a primary power source.

It should be noted that all the drawings are diagrammatic and not drawn to scale. Relative dimensions and proportions of parts of these figures have been shown exaggerated or reduced in size for the sake of clarity and convenience in the drawings. The same reference numbers are generally used to refer to corresponding or similar features in the different embodiments. Accordingly, the drawing(s) and description are to be regarded as illustrative in nature and not as restrictive.

### DETAILED DESCRIPTION OF THE PREFERRED EMBODIMENT

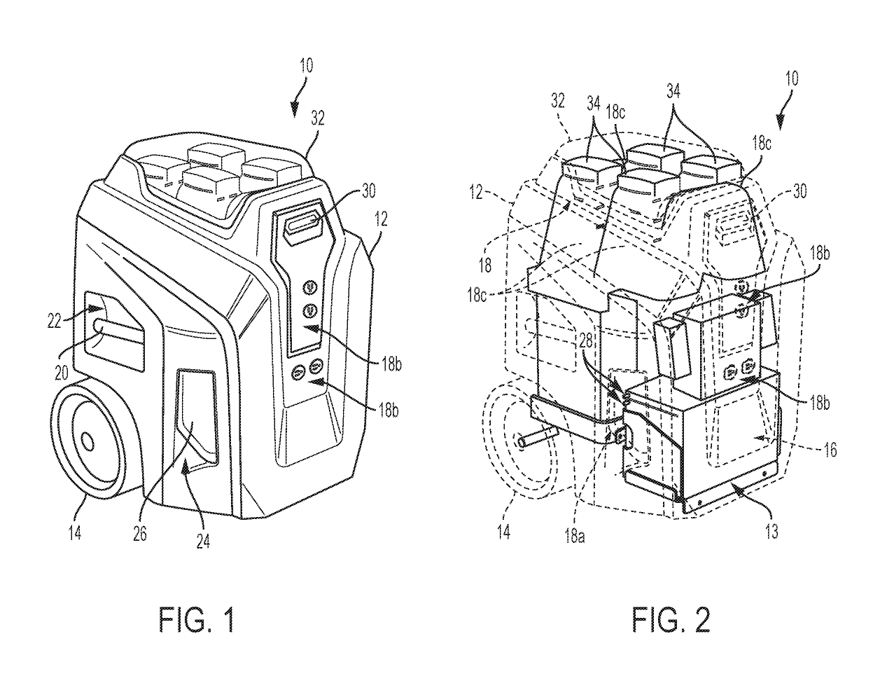

Referring to FIG. 1, an exemplary embodiment of a portable charging station 10 for a handheld tool is shown. The charging station 10 is configured to be a mobile station that increases productivity at worksites, wherein the charging station 10 provides multiple electrical connectors adapted to provide output power to a tool or for recharging a plurality of rechargeable batteries. The charging station 10 is easily portable and is rechargeable itself which allows the charging station 10 to be moved to any location at a worksite without having to utilize electrical power from the worksite itself. In an embodiment, the charging station 10 includes a housing 12, a plurality of wheels 14, at least one primary power source 16, and a plurality of charging ports 18. The charging station 10 can be configured to be manually portable in which the user pulls, lifts, or otherwise physically moves the charging station 10 or automatically portable in which a transmission 70 moves the charging station 10 in response to a remote control command by a user, an electronic tether, or the like. In the illustrated embodiment, the charging station 10 includes an extendable handle (not shown) that extends upwardly from the rear of the housing 12 to allow an operator to pull the charging station 10 from one location to another. In an embodiment, the wheels 14 are formed as heavy-duty non-pneumatic tires.

In an embodiment, a primary power source 16, as shown in FIG. 2, is located within the housing 12. The primary power source 16 is a rechargeable member that is operatively and electrically connected to each of the charging ports 18. In an embodiment, the primary power source 16 includes a single rechargeable battery. In the illustrated embodiment, the primary power source 16 includes a plurality of rechargeable batteries. The primary power source 16 can be formed from at least one lead-acid battery, NiMH, NiCD, Lithium ion, or other similar type of rechargeable battery. The primary power source 16 is attached to the housing 12 by way of a bracket 13, thereby holding the primary power source 16 in place within the housing 12.

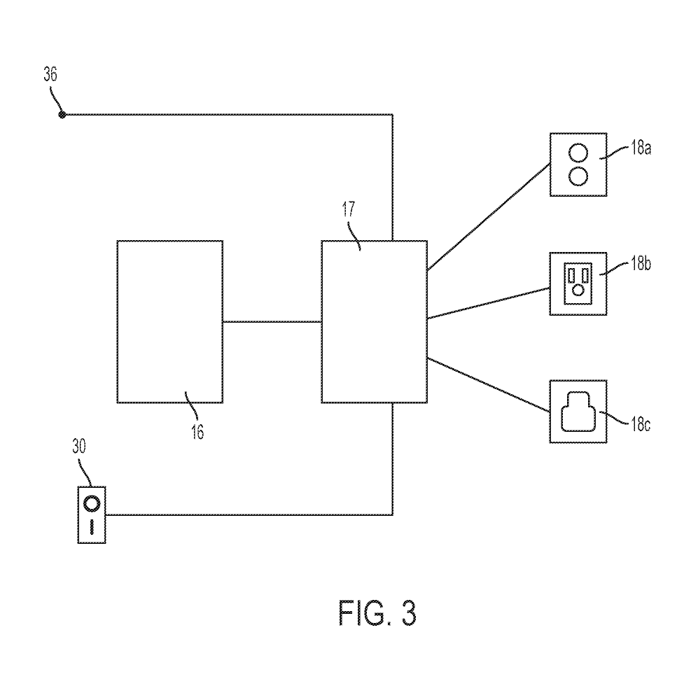

In an embodiment, the primary power source 16 is directly connected (electrically) to each of the charging ports 18. In the schematic diagram of another embodiment shown in FIG. 3, the primary power source 16 is operatively and electrically connected to a controller 17, wherein the controller 17 is located within or on an exterior surface the housing 12. The controller 17 is configured to ensure proper conversion of the electrical power flowing into the primary power source 16 as well as ensure proper conversion of the electrical power flowing from the primary power source 16 to each of the charging ports 18, as will be explained in more detail below.

The housing 12 of the charging station 10, as shown in FIGS. 1-2, is generally square, wherein a pair of wheels 14 are rotatably connected to the rear of the housing 12 adjacent to opposing lateral sides thereof. The housing 12 includes a pair of handles 20 located on opposing lateral sides of the housing 12, wherein each handle 20 is positioned adjacent to one of the wheels 14. The handles 20 are configured to allow a user to lift and move the charging station 10 as well as allow the charging station 10 to be secured within a vehicle using tie-downs or straps (not shown). Each handle 20 is located within a detent or first recess 22 formed into each of the lateral sides of the housing 12.

The housing 12 further includes a second recess 24 positioned adjacent to each of the first recesses 22, as shown in FIGS. 1-2. A cover 26 is positioned over the second recess 24, and the cover 26 is rotatably attached to the side portion or the front portion of the housing 12. A first charging port 18a is positioned beneath the cover 26 and operatively attached to the housing 12. The first charging port 18a is formed as a first type of connector such as a pair of studs 28 configured to allow jumper cables (not shown) to be attached to the pair of studs 28 such that the jumper cables extend between the studs 28 and a battery in an automobile, lawn maintenance vehicle, or any other vehicle or tool having a battery that can be charged by jumper cables. The first charging port 18a is operatively and electrically connected to the primary power source 16, wherein the primary power source 16 provides electrical power to the first charging port 18a to power the device connected to the first charging port 18a.

A plurality of second charging ports 18b are positioned on the forwardly-directed surface of the housing 12, as shown in FIG. 1. It should be understood by one having ordinary skill in the art that the second charging ports 18b can be located on any single surface of the housing 12 or even being positioned on more than one surface of the housing 12. The second charging ports 18b are operatively and electrically connected to the primary power source 16, wherein the primary power source 16 provides electrical power to the second charging ports 18b to power the device(s) connected to the second charging port 18b. The second charging ports 18b are formed as a second type of connector such as power outlets, or power receptacles, into which extension cords or power cords for powered handheld tools, electric mowers, or the like can be inserted. In the illustrated embodiment, the second charging ports 18b include a pair of receptacles that provide fifteen (15) amp power, and another pair of receptacles that provide twenty (20) amp power. It should be understood by one having ordinary skill in the art that any number of receptacles providing any amperage can be used for the second charging ports 18b. The second charging ports 18b are formed of a different type of connector than the first charging port 18a, thereby providing a user with different forms of connectors or ports for charging or providing power to larger variety of components, vehicles, or tools.

The charging station 10 further includes a power button 30, as shown in FIGS. 1 and 3. The power button 30 is configured to switch the recharging (or power-providing) activity of the primary power source 16, and thus the charging station 10 itself, between an active state and an inactive state. When the primary power source 16 is in an active state, the primary power source 16 provides power to each of the charging ports 18. When the primary power source 16 is in an inactive state, the primary power source 16 does not provide power to any of the charging ports 18. In another embodiment, the charging station 10 can include a plurality of power buttons 30 positioned on the housing 12, wherein each of the power buttons is configured to selectively switch one charging port 18 (or a set of similar charging ports) between an active state and an inactive state. In an embodiment, the power button 30 is pulled out to switch the charging station 10 to an active state and pushed in to switch the charging station 10 to an inactive state. In the illustrated embodiment, the power button 30 is an on/off switch, but it should be understood by one having ordinary skill in the art that any mechanism can be used that allows an operator to easily switch the charging station 10 between an active state and an inactive state. As shown in FIG. 3, the power button 30 is operatively and electrically connected to the controller 17.

The housing 12 further includes a lid 32 positioned on the top surface thereof, as shown in FIGS. 1-2. The lid 32 is either removable or rotatable relative to the top surface of the housing 12. The lid 32 can be formed as a transparent material that allows a user to see through the lid 32. In other embodiments, the lid 32 can be formed as an opaque material. The lid 32 provides protection for a plurality of charging ports 18 positioned thereunder.

The charging ports 18 positioned below the lid 32 include a plurality of third charging ports 18c, as shown in FIG. 2. Each of the third charging ports 18c is operatively and electrically connected to the primary power source 16, wherein the primary power source 16 provides electrical power to each of the third charging ports 18c to power the device(s) connected to the third charging ports 18c. In an embodiment, each of the third charging ports 18c are formed as a connector such as a recharging port configured to receive a replaceable secondary rechargeable battery 34. The secondary rechargeable batteries 34 are selectively placeable into (or removed from) the third charging ports 18c to be recharged using power transferred from the primary power source 16 to the secondary rechargeable battery 34 by way of the third charging port 18c into which the secondary rechargeable battery 34 is placed. The third charging ports 18c are configured to transfer the stored power from the primary power source 16 to the secondary rechargeable batteries 34 placed in the third charging ports 18c. The third charging ports 18c are configured as different forms of connectors in order to provide or transfer power to different types of components than the first and second charging ports 18a, 18b. In an embodiment, the charging station 10 includes eight (8) third charging ports 18c, but it should be understood by one skilled in the art that the charging station 10 can include any number of third charging ports 18c.

Although the exemplary embodiment shown in FIGS. 1-2 and described herein includes three separate and distinct types of charging ports, it should be understood by one having ordinary skill in the art that the charging station 10 can include any number of different types and forms of connectors for the charging ports 18, depending on the various types of implements or tools intended to receive power from the primary power source 16.

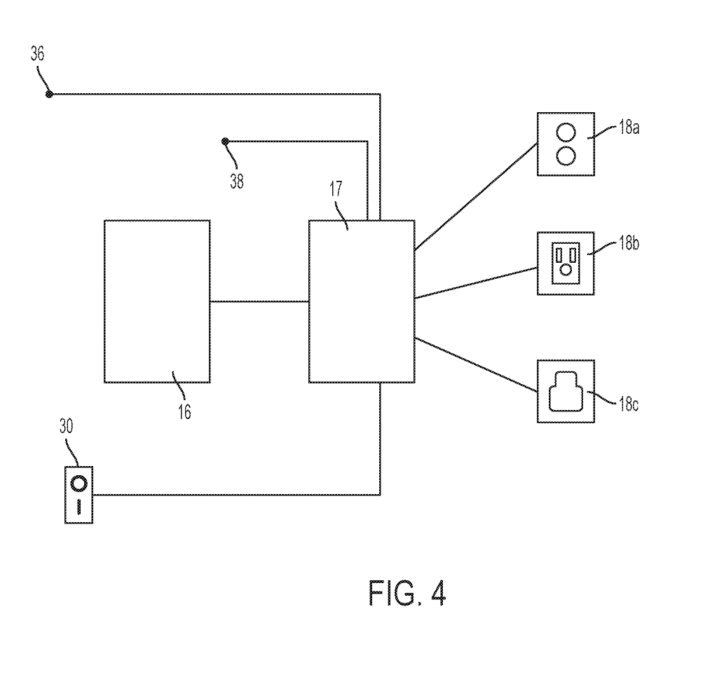

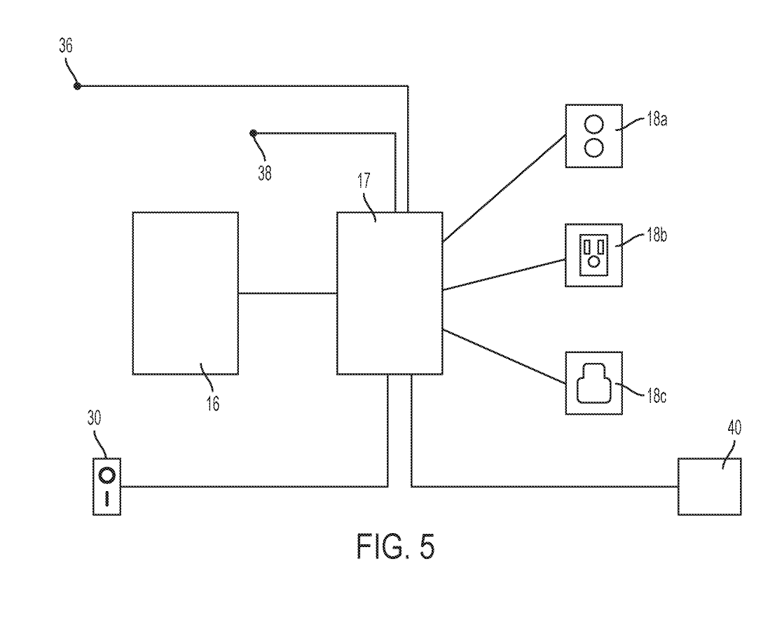

In an embodiment, the charging station 10 further includes a retractable charging cord 36 which allows the primary power source 16 to be operatively and electrically connected to a home outlet or receptacle so as to charge/recharge the primary power source 16, as shown in FIG. 3. The primary power source 16 is rechargeable, which allows the charging station 10 to provide a mobile power source (by way of the first or second charging ports 18a, 18b) or a mobile recharging source (by way of the third charging ports 18c). The power cord 36 allows a user to recharge the primary power source 16 of the charging station 10 during a time when the charging station 10 is not needed using conventional home outlets. In another embodiments, shown in FIG. 4, the charging station 10 also includes a secondary cord 38 that can be plugged into an automobile receptacle that can recharge the primary power source 16 by way of a trickle charge while driving. Although a trickle charge through the secondary cord 38 is not expected to fully recharge the primary power source 16 on trips between worksites, the trickle charge can provide at least some amount of refreshing charge to the primary power source 16 to allow the primary power source 16 to last even longer during a workday. The recharged primary power source 16 can then, in turn, provide recharging power to the first, second, and third charging ports 18a, 18b, 18c. In another embodiment, the charging station 10 additionally includes a removable solar panel 40 that is operatively and electrically connected to the primary power source 16 to provide additional recharging to the primary power source 16, as shown in FIG. 5. The solar panel 40 can be attached to either the housing 12 or to a worktruck or other vehicle, which allows the primary power source 16 to be recharged even when the primary power source is providing electrical power to the charging ports 18. In another embodiment, the solar panel 40 is configured to recharge a separate primary power source 16 that is not onboard the charging station 10 while the charging station 10 is being used on a worksite. The primary power source 16 is removable and exchangeable, such that if the primary power source becomes sufficiently discharged during the day, the replacement primary power source 16 can be switched with one that has been charged by the solar panel(s) 40.

As explained above, the primary power source 16 is operatively and electrically connected to each of the charging ports 18, including the first charging port 18a, the second charging ports 18b, and the third charging ports 18c, as shown in the schematic diagram of FIG. 3. Each of the charging ports 18 is connected to the primary power source 16 by way of a controller 17. The controller 17 is configured to convert—where necessary—the electrical power from the primary power source 16 to the proper type of power utilized by each of the charging ports 18. The controller 17 is also configured to convert—where necessary—the electrical power from the charging source (power cord 36, secondary cord 38, or solar panel 40) to the primary power source 16. The controller 17 is also configured to measure and track the amount of power remaining and/or discharged from the primary power source 16. This measured amount of remaining power in the primary power source 16 can then be displayed by way of a user interface on positioned in the housing 12 or by way of a handheld device 52, as explained below.

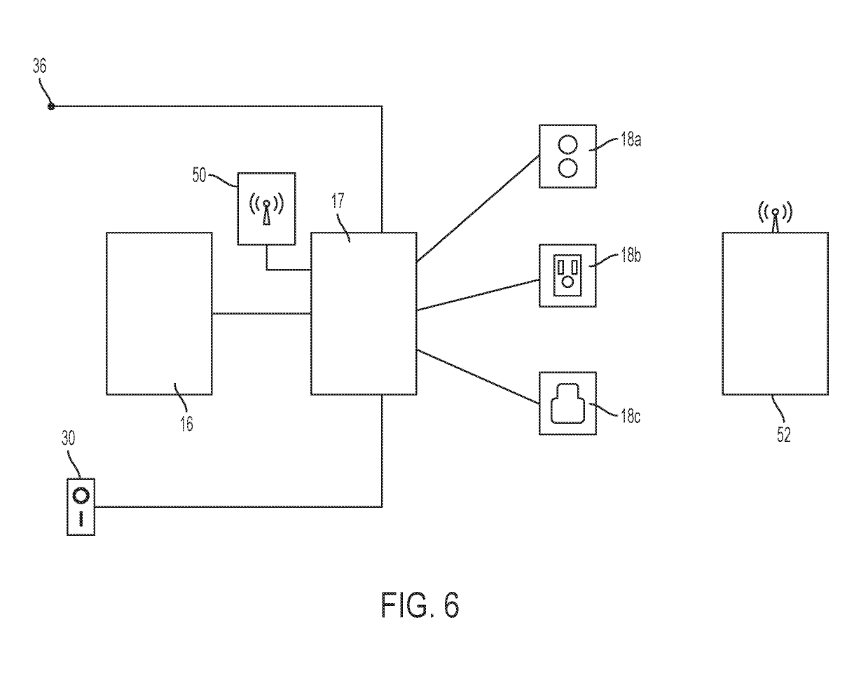

In the embodiment shown in FIG. 6, the controller 17 within the housing 12 of the charging station 10 is operatively connected to a signal generator 50 configured to generate an output wireless signal. The wireless signal is receivable by a handheld device 52, such as a tablet computer, a smartphone, laptop computer, or other device capable of receiving the signal from the signal generator 50 and providing an output display of the information provided in the wireless signal. The output wireless signal can include information such as current power level of the primary power source 16, a warning once the primary power source 16 goes below a pre-determined power level, the number and type of charging port 18 currently being utilized, the ratio or amount of power used by each of the different types of (or each individual) charging ports 18, estimated amount of time remaining on the charge of the primary power source 16, or any other information that can be useful to an operator. The handheld device 52 receiving the output wireless signal can include an application that is configured to cooperate with the controller 17 and signal generator 50 of the charging station 10 in order to send and receive information for the charging station 10. The handheld device 52 utilizes the on-board application to provide a user interface to display the information from the controller 17 as well as provide operator feedback to the controller 17. The controller 17 can provide real-time performance data from the charging station 10, which also allows the operator to receive immediate feedback warnings from the charging station 10. In an embodiment, the application on the handheld device 52 can allow an operator to control the charging characteristics of the third charging ports 18c such as controlling whether the recharging of the secondary batteries 34 is done in an expedited manner or over an extended time period.

In another embodiment, the controller 17 and the application on the handheld device 52 can work in cooperation with the signal generator 50 (or separately therefrom) to provide a global positioning system (GPS) signal that allows an owner of the charging station to track the location of the charging station 10 if it becomes stolen.

In operation, the user plugs the charging station 10 into a home wall outlet, an automobile power outlet (while the automobile is running), and/or the solar panel 40 in order to recharge the primary power source 16. Once the primary power source 16 is fully charged (or even if it is only partially charged), the user can transport the charging station 10 to a location that is not dependent upon a home outlet or the like for power. The charging station 10 provides both a mobile power supply—even acting as a substitute for a gas-powered generator for a short time period—as well as a mobile power source for recharging secondary rechargeable batteries that are then used with handheld power tools.

For example, if the user utilizing a lawn maintenance tool such as a leaf blower for lawn maintenance having a rechargeable battery, the user can transport the charging station 10 to the location or area being maintained. Once the rechargeable battery of the leaf blower has expended its power supply, the secondary rechargeable battery 34 can be placed into one of the third charging ports 18c where it can be recharged by power being transferred from the primary power source 16 to the secondary rechargeable battery 34 via the third charging port 18c. Because some embodiments of the charging station 10 include a plurality of third charging ports 18c, a secondary rechargeable battery 34 can be positioned in each of the third charging ports 18c such that when the rechargeable battery on the leaf blower is discharged, a fully-charged replacement rechargeable battery is available to be removed from one of the third charging ports 18c and the expended rechargeable battery can be inserted into the empty third charging port 18c for recharging. In an embodiment, the third charging ports 18c include a visual indicator that signals when the secondary rechargeable battery 34 has been fully charged.

In another example, if the user is utilizing a riding lawn mower that has an on-board battery that completely discharges such that the lawn mower stops working, the user can transport the charging station 10 to the stopped lawn mower. The battery of the lawn mower can be hooked up to the studs of the first charging port 18a in order to recharge the on-board battery of the lawn mower a sufficient amount to allow the user to start the mower and then ride/drive the lawn mower to the garage or to a location in which the lawn mower can be fixed. The ease of transporting the charging station 10 to the lawn mower is much more efficient than moving the stopped lawn mower to a location at which maintenance can be performed. The primary power source 16 of the charging station is sufficient to provide enough power to jump-start the lawn mower or even an automobile.

In yet another example, the charging station 10 can be used by a commercial landscaping crew. The charging station 10 can be plugged into a home receptacle overnight using the power cord 36 to recharge the primary power source 16, and in the morning, the charging station 10 can be transported to each site being landscaped. Some landscapers on the crew can utilize corded handheld tools such as string trimmers, hedge trimmers, or the like by plugging these tools into the second charging ports 18b formed as power outlets while other landscapers on the same crew utilizing battery-powered handheld tools have a plurality of (secondary) rechargeable batteries 34 readily available and continuously recharged by the third charging ports 18c. While the landscaping crew is moving from one location to another, the charging station 10 can be plugged into an electrical outlet, receptacle, or lighter port on the vehicle to provide intermittent re-charging for the primary power source 16.

In an embodiment, the charging station 10 can include an integrated transmission 70 that is configured to selectively drive the wheels 14. The transmission 70 is controlled by the on-board controller 17, wherein the controller 17 cooperates with the signal generator 50 that is configured to communicate with a corresponding handheld device 52, such as a tether that can be worn by the user. The controller 17 and tether 52 communicate with each other to provide an electronic tether between the user and the charging station 10. The controller 17 can be configured to control the transmission 70 so that the charging station 10 follows the user by staying within a pre-determined distance. The electronic tether can be activated or deactivated by the receiver/transmitter on the operator.

The portable charging station 10 provides a primary power source 16 that is rechargeable and operatively connected to a plurality of charging ports 18, wherein at least two of the charging ports 18 are configured to provide a different form of power output such as a short burst of power through the first charging port 18a for jump-starting a vehicle, longer-term, or continuous power supply through the second charging ports 18b via power receptacles, or recharging power through the third charging ports 18c for recharging secondary rechargeable batteries 34. It should be understood that the charging station 10 can include any number of different forms of connectors for transferring electrical power stored in the primary power source 16 to an external component or tool.

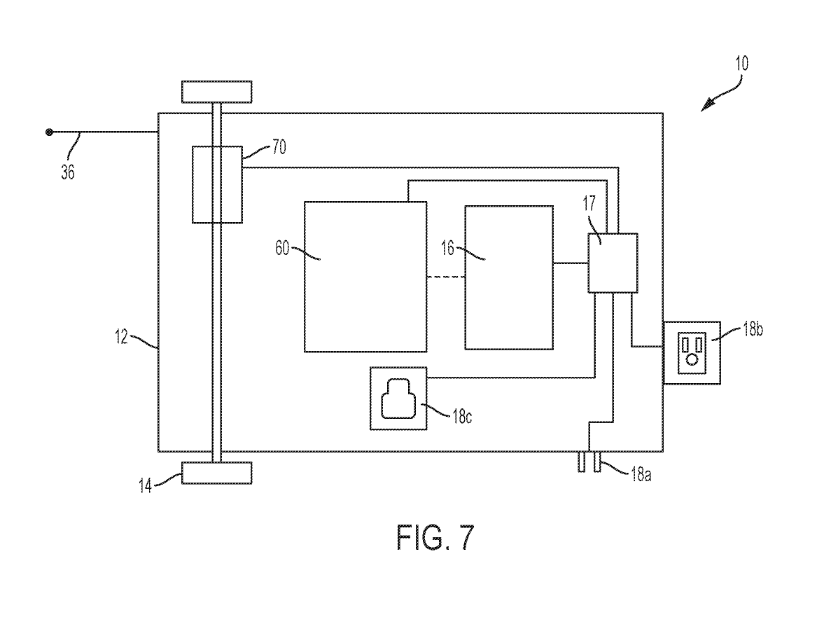

In an embodiments, the charging station 10 includes an internal combustion engine 60 positioned within the housing 12, as shown in FIG. 7. The internal combustion engine 60 is operatively and electrically connected to the primary power source 16. In the illustrated embodiment, the internal combustion engine 60 is electrically connected to the primary power source 16 by way of the controller 17. The internal combustion engine 60 is configured to transmit electrical power to the primary power source 16 in order to recharge the primary power source 16 or to transfer electrical power to the charging ports 18. The transfer of electrical power from the internal combustion engine 60 can be achieved by routing the electrical power through the controller 17 to the primary power source 16 before it travels back through the controller 17 to one of the charging ports 18. The transfer of electrical power from the internal combustion engine 60 can also be achieved by routing the electrical power through the controller 17 then directly to the charging port(s) 18, wherein the electrical power being directed to the charging port(s) 18 bypasses the primary power source 16. In another embodiment, a portion of the electrical power generated by the internal combustion engine 60 is diverted to the primary power source 16 while another portion of the electrical power generated by the engine 60 is transferred directly to the charging port(s) 18 via the controller 17. In an embodiment, the charging station 10 further includes a switch (not shown) that allows an operator to selectively determine whether the charging ports 18 are powered directly by the primary power source 16, directly from the internal combustion engine 60 (through the controller 17), or indirection from the internal combustion engine 60 through the primary power source 16 (if/when the primary power source 16 is drained of power).

While preferred embodiments of the present invention have been described, it should be understood that the present invention is not so limited and modifications may be made without departing from the present invention. The scope of the present invention is defined by the appended claims, and all devices, processes, and methods that come within the meaning of the claims, either literally or by equivalence, are intended to be embraced therein.

What is claimed is:

1. A portable charging station comprising:
a housing;
a primary power source located within said housing, wherein said primary power source is rechargeable; and
a plurality of charging ports located on said housing, said plurality of charging ports being operatively and electrically connected to said primary power source, each of said plurality of charging ports providing electrical output power therefrom, wherein at least two of said plurality of charging ports are different forms of connectors.

2. The portable charging station of claim 1, wherein said charging ports provide different forms of output power including a short burst power supply, a continuous power supply, or a recharging power supply.

3. The portable charging station of claim 1, wherein one of said plurality of charging ports is a pair of studs for jump-starting a vehicle.

4. The portable charging station of claim 1, wherein at least one of said plurality of charging ports is a power receptacle for providing a continuous power supply.

5. The portable charging station of claim 4, wherein said power receptacle provides a 15 amp power supply.

6. The portable charging station of claim 4, wherein said power receptacle provides a 20 amp power supply.

7. The portable charging station of claim 4, wherein at least one of said plurality of charging ports includes two power receptacles, wherein one of said power receptacles provides a 15 amp power supply and the other of said power receptacles provides a 20 amp power supply.

8. The portable charging station of claim 1, wherein at least one of said plurality of charging ports is a recharging port for receiving a rechargeable secondary battery.

9. The portable charging station of claim 1, wherein said plurality of charging ports includes only two different forms of connectors.

10. The portable charging station of claim 1, wherein said plurality of charging ports includes at least three different forms of connectors.

11. A portable charging station comprising:
a housing;
a primary power source located within said housing, wherein said primary power source is rechargeable;
a first charging port operatively and electrically connected to said primary power source, wherein said first charging port provides a first form of power output;
a second charging port operatively and electrically connected to said primary power source, wherein said second charging provides a second form of power output; and
a third charging port operatively and electrically connected to said primary power source, wherein said third charging port provides a third form of power output.

12. The portable charging station of claim 11, wherein said first charging port is formed as a pair of studs for providing a short burst of output power.

13. The portable charging station of claim 11, wherein said second charging port is formed as a power receptacle for providing continuous power.

14. The portable charging station of claim 13, wherein power receptacle provides output power at 15 amp or 20 amp power output.

15. The portable charging station of claim 11, wherein said third charging port is formed as a recharging port for receiving a secondary rechargeable battery therein to provide recharging power.

16. The portable charging station of claim 11, wherein said first, second, and third forms of power output are different from each other

17. The portable charging station of claim 11, wherein said primary power source is rechargeable by electrically connecting said primary power source to a home power receptacle or automobile power port.
